(19) United States
(12) Patent Application Publication
(10) Pub. No.: US 2023/0334224 A1
(43) Pub. Date: Oct. 19, 2023

(54) Systems And Methods For Multi-Media Aggregator & Information Hub

(71) Applicant: Richard Crump, Lowell, MA (US)

(72) Inventor: Richard Crump, Lowell, MA (US)

(21) Appl. No.: 18/337,009

(22) Filed: Jun. 18, 2023

Related U.S. Application Data
(60) Provisional application No. 62/353,612, filed on Jun. 23, 2016.

(51) Int. Cl. G06F 40/12; G06F 3/16

(52) U.S. Cl. CPC G06F 40/12; G06F 3/167

(57) ABSTRACT

Systems and methods for aggregating multi-media sources and streamlining delivery of political information are provided herein. In one aspect of this disclosure, a method for aggregating multi-media sources and streamlining delivery of political information includes receiving, at an input of a news server, a request from a client coupled to the news server, the request relating to at least one function or operation of a multi-media aggregator and information hub system. At least one action may be taken or performed in response to the client request. For example, the at least one action may include one or more of sending a page containing a news client interface from the news server to the client in response to the request from the client corresponding to a request for latest political news.

### CROSS REFERENCE TO RELATED APPLICATION

This application claims the benefit of and priority to U.S. Provisional Application No. 62/353,612, filed on Jun. 19, 2022 under 35 U.S.C. § 119(e), which application is incorporated by reference herein in its entirety.

### FIELD

This disclosure relates generally to systems and methods for aggregating multi-media sources and delivery of political information, for example elected officials and local political party committees.

### BACKGROUND

In recent years the general public has become more interested in following political news stories and desires to be more politically active. Unfortunately, the general public lacks the knowledge to keep informed about political news. They also commonly don't know the names of their elected officials and don't know how to reach out to their local party committees.

The many news organizations' websites, online political talk shows, web-based political broadcast shows, and current events podcast channels all play a part in disseminating political news. State election boards have a hand in informing the general public of their elected officials. And state-wide political party committees can help identify local county or town committees' contact information.

It can be bewildering and time consuming for the general public to track down the desired political information and to keep up with the political news.

### SUMMARY

Described herein are systems and methods related to aggregating multi-media sources and delivery of political information over a computer network. More particularly, in one aspect of this disclosure, a system of aggregating multi-media sources and delivery of political information over a computer network includes a website for displaying political news stories, listening to political news stories, listening to online political talk shows, watching political broadcast shows, watching current events podcast channels, finding elected officials contact information, locating local political party committees, breaking news social media messages, leading voices social media messages, and politician's social media messages.

The system also includes a server that processes latest news requests, listen news requests, live media requests, watch podcast requests, elected officials requests, political party requests, breaking news requests, leading voices requests, and elected officials social media messages request. News stories meta-data, live media shows meta-data, podcasts meta-data, elected officials meta-data, and political party committees meta-data are stored on a database associated with the system.

A method of aggregating multi-media sources and delivery of political information is also provided. In one aspect, the method includes receiving, at an input of a news server, a request from a client coupled to the news server, the request relating to at least one function or operation of a multi-media aggregator and delivery of political information system.

In response to the request from the client corresponding to a request for latest news, a page containing a news client interface may be sent from the news server to the client. A memory device (or memory devices) associated with the news server may be searched for news stories meta-data, and the news stories meta-data may be provided to the client. In accordance with some embodiments of this disclosure, the news stories meta-data is provided on one or more image and text files on the memory device(s).

In response to the request from the client corresponding to a request for listen news, a page containing a listen client interface may be sent from the news server to the client. A memory device (or memory devices) associated with the news server may be searched for news stories meta-data, and the news stories meta-data may be provided to the client. In accordance with some embodiments of this disclosure, the news stories meta-data is provided on one or more image and text files on the memory device(s).

In some embodiments, in response to receiving the news stories meta-data, the news story headlines are prepared for playback. The news story headlines will be processed for abbreviation expansion and the news story headlines will be processed to have specific words transpose so the words can be pronounced by the synthesis voice better, as described further below.

In response to the request from the client corresponding to a request for live media program guide, a page containing a live media client interface may be sent from the news server to the client. A memory device (or memory devices) associated with the news server may be searched for live media shows meta-data, and the live media shows meta-data may be provided to the client. In accordance with some embodiments of this disclosure, the live media shows meta-data is provided on one or more image and text files on the memory device(s).

In some embodiments, the live client interface provides the ability to switch the day focus of the live media program guide being displayed, as described further below.

In response to the request from the client corresponding to a request to watch podcasts, a page containing a podcast client interface may be sent from the news server to the client. A memory device (or memory devices) associated with the news server may be searched for podcast meta-data, and the podcast meta-data may be provided to the client. In accordance with some embodiments of this disclosure, the podcast meta-data is provided on one or more image and text files on the memory device(s).

In response to the request from the client corresponding to a request for elected officials, a page containing an officials client interface may be sent from the news server to the client. A memory device (or memory devices) associated with the news server may be searched for elected officials meta-data, and the elected officials meta-data may be provided to the client. In accordance with some embodiments of this disclosure, the elected officials meta-data is provided on one or more image and text files on the memory device(s).

In some embodiments, the officials client interface provides the ability to switch the state and political branch focus of the elected officials being displayed, as described further below.

In response to the request from the client corresponding to a request for political party, a page containing a party client interface may be sent from the news server to the client. A memory device (or memory devices) associated with the news server may be searched for political party committees meta-data, and the political party committees meta-data may be provided to the client. In accordance with some embodiments of this disclosure, the political party committees meta-data is provided on one or more image and text files on the memory device(s).

In some embodiments, the party client interface provides the ability to switch the state and county/town focus of the political party committees being displayed, as described further below.

In response to the request from the client corresponding to a request for breaking news, a page containing a breaking client interface may be sent from the news server to the client. A memory device (or memory devices) associated with the social media server may be searched for breaking news messages corresponding to the multi-media aggregator and delivery system account, and the messages may be provided to the client. In accordance with some embodiments of this disclosure, the messages are provided on one or more image and text files on the memory device(s).

In response to the request from the client corresponding to a request for leading voices, a page containing a leading client interface may be sent from the news server to the client. A memory device (or memory devices) associated with the social media server may be searched for leading voices messages corresponding to the multi-media aggregator and delivery system account, and the messages may be provided to the client. In accordance with some embodiments of this disclosure, the messages are provided on one or more image and text files on the memory device(s).

It will be appreciated that the systems and methods disclosed herein simplify the process of following political news stories, staying political informed, and getting more politically active. For example, trying to find a political talk radio show to listen to, and with the systems and methods disclosed herein the process of seeing the available shows time information associated these shows may occur more efficiently and effectively, as will be become further apparent from discussions below.

While the systems and methods disclosed herein are often discussed with reference to political information, it is understood that the disclosed systems and methods may also be utilized in other applications. For example, it is contemplated that the disclosed systems and methods may also be applied to other information needs. For example, financial or cooking information, it may be helpful for people to be able to easily find the contents from multiple sources that they are interested in. The information may be from websites, podcasts, live talk shows, live broadcast show or a combination thereof.

Additional advantages and example uses of the present invention will become further apparent from discussions below.

### BRIEF DESCRIPTION OF THE DRAWINGS

The invention may be understood with reference to the following drawings, which are not necessarily to scale. Also, in the drawings, like reference numerals designate corresponding parts throughout the several views.

FIG. 1 is a block diagram of an example multi-media aggregator and information hub system, according to an embodiment of the present invention;

FIG. 2a is a flowchart illustrating example operations/functionality of a multi-media aggregator and information hub system in accordance with embodiments of this disclosure, for example, the multi-media aggregator and information hub system of FIG. 1, for a first example type of client of the multi-media aggregator and information hub system;

FIG. 2b is a flowchart illustrating example operations/functionality of a multi-media aggregator and information hub system in accordance with embodiments of this disclosure, for example, the multi-media aggregator and information hub system of FIG. 1, for a second example type of client of the multi-media aggregator and information hub system;

FIG. 2c is a flowchart illustrating example operations/functionality of a multi-media aggregator and information hub system in accordance with embodiments of this disclosure, for example, the multi-media aggregator and information hub system of FIG. 1, for a third example type of client of the multi-media aggregator and information hub system;

FIG. 2d is a flowchart illustrating example operations/functionality of a multi-media aggregator and information hub system in accordance with embodiments of this disclosure, for example, the multi-media aggregator and information hub system of FIG. 1, for a fourth example type of client of the multi-media aggregator and information hub system;

FIG. 2e is a flowchart illustrating example operations/functionality of a multi-media aggregator and information hub system in accordance with embodiments of this disclosure, for example, the multi-media aggregator and information hub system of FIG. 1, for a fifth example type of client of the multi-media aggregator and information hub system;

FIG. 2f is a flowchart illustrating example operations/functionality of a multi-media aggregator and information hub system in accordance with embodiments of this disclosure, for example, the multi-media aggregator and information hub system of FIG. 1, for a sixth example type of client of the multi-media aggregator and information hub system;

FIG. 2g is a flowchart illustrating example operations/functionality of a multi-media aggregator and information hub system in accordance with embodiments of this disclosure, for example, the multi-media aggregator and information hub system of FIG. 1, for a seventh example type of client of the multi-media aggregator and information hub system;

FIG. 2h is a flowchart illustrating example operations/functionality of a multi-media aggregator and information hub system in accordance with embodiments of this disclosure, for example, the multi-media aggregator and information hub system of FIG. 1, for an eighth example type of client of the multi-media aggregator and information hub system;

FIG. 2i is a flowchart illustrating example operations/functionality of a multi-media aggregator and information hub system in accordance with embodiments of this disclosure, for example, the multi-media aggregator and information hub system of FIG. 1, for a ninth example type of client of the multi-media aggregator and information hub system;

FIG. 3 is an example screen representation of an initial client interface in accordance with embodiments of this disclosure;

FIG. 4 is an example screen representation of a news client interface in accordance with embodiments of this disclosure;

FIG. 5 is an example screen representation of a listen client interface in accordance with embodiments of this disclosure;

FIG. 6 is an example screen representation of a live media client interface in accordance with embodiments of this disclosure;

FIG. 7 is an example screen representation of a podcast client interface in accordance with embodiments of this disclosure;

FIG. 8 is an example screen representation of an elected officials client interface in accordance with embodiments of this disclosure;

FIG. 9 is an example screen representation of a party client interface in accordance with embodiments of this disclosure;

FIG. 10 is an example screen representation of a breaking news client interface in accordance with embodiments of this disclosure;

FIG. 11 is an example screen representation of a leading voices messages client interface in accordance with embodiments of this disclosure;

FIG. 12 is an example screen representation of an elected officials messages client interface in accordance with embodiments of this disclosure.

### DETAILED DESCRIPTION

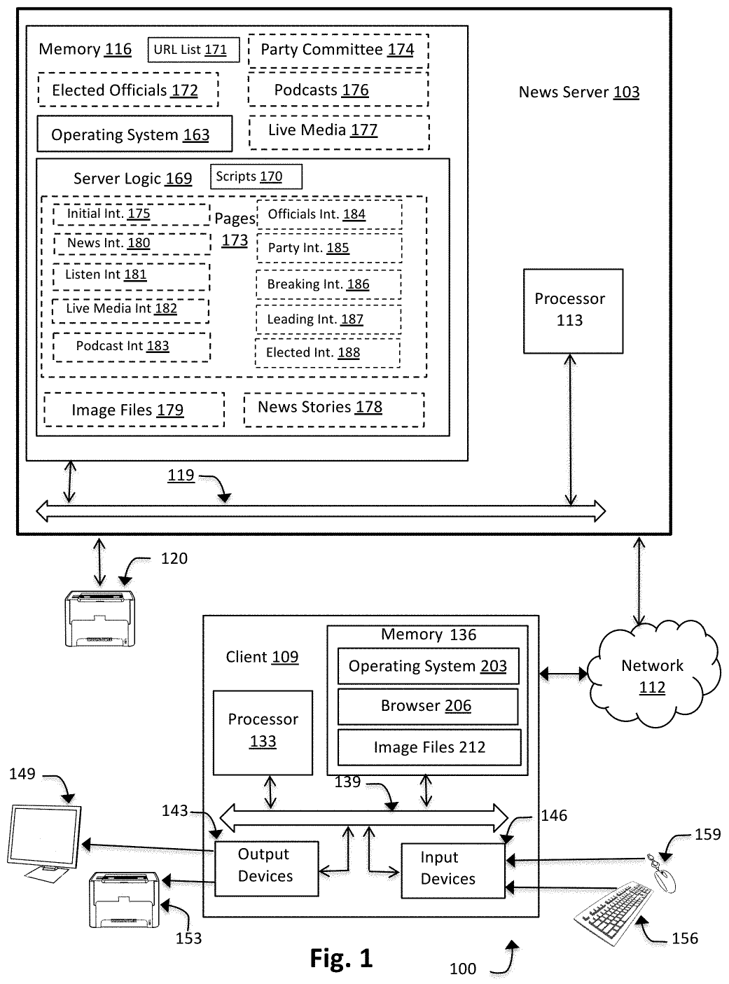

Referring to FIG. 1, an example multi-media aggregator and information hub system 100 according to an embodiment of this disclosure is shown. As illustrated in FIG. 1, the multi-media aggregator and information hub system 100 includes a news server 103 and a client 109, all of which are coupled to a network 112. The news server 103, which may manage news sites URL list, news stories, podcasts, live media steaming channels, elected officials, and local political party committees, for example, may include, a computer system or other apparatus with similar capability. In particular, the news server 103 may include a processor circuit with a processor 113 and a memory 116, both of which are coupled to a local interface 119. The local interface 119 may include, for example, a data bus with an accompanying control/address bus, as is generally known by those with ordinary skill in the art.

Various peripheral devices may be coupled to the local interface 119. In particular, peripheral devices may include, for example, a keyboard, keypad, touch pad, touch screen, microphone, scanner, mouse, joystick, or one or more push buttons, etc. The peripheral devices may also include display devices, indicator lights, speakers, etc. Specific display devices may be, for example, cathode ray tubes (CRTs), liquid crystal display screens, gas plasma-based flat panel display, or other types of display devices, etc. For example, the news server 103 may have a printer 120 attached thereto via the local interface 119.

The client 109 may also include a computer system or other system with similar capability. For example, the client 109 may include a desktop computer, a laptop computer, a handheld computer, a tablet computer, a smart phone, and/or the like. The client 109 includes a processor circuit with a processor 133 and a memory 136, both of which are coupled to a local interface 139. The local interface 139 may be a data bus with an accompanying control/address bus. The client 109 also includes various output interfaces 143 and input interfaces 146 (referred to as devices in FIG. 1), through which the client 109 may be connected to various peripheral devices. Such peripheral devices may include a display device 149, a printer 153, a keyboard 156, and a mouse 159. Other peripheral devices that may be employed by the client 109 to receive various user input and/or to provide user output, include those listed above with regard to the news server 103.

The memories 116 and 136 are defined herein as both volatile and non-volatile memory and data storage components. Volatile components are those that do not retain data values upon loss of power. Non-volatile components are those that retain data upon a loss of power. Thus, the memories 116 and 136 may comprise, for example, random access memory (RAM), read-only memory (ROM), hard disk drives, floppy disks accessed via an associated floppy disk drive, compact discs accessed via a compact disc drive, magnetic tape accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, each of the processors 113 and 133 may represent multiple processors and each of the memories 116 and 136 may represent multiple memories that operate in parallel. In such a case, the local interfaces 119 and 139 may be appropriate networks that facilitate communication between any of the multiple processors, between any processor and any one of the memories, or between any two of the memories etc. The processors 113 and 133 may be electrical or optical in nature.

The network 112 includes, for example, the Internet, intranets, wide area networks (WANs), local area networks (LANs), wireless networks, or other suitable networks, etc., or any combination of such networks. The news server 103 and the client 109 may be coupled to the network 112 in one of the any number of ways known by those with ordinary skill in the art so as to facilitate data communication to and from the network 112. In this respect, the news server 103 and the client 109 may be linked to the network 112 through various devices such as, for example, network cards, modems, or other such communications devices, etc.

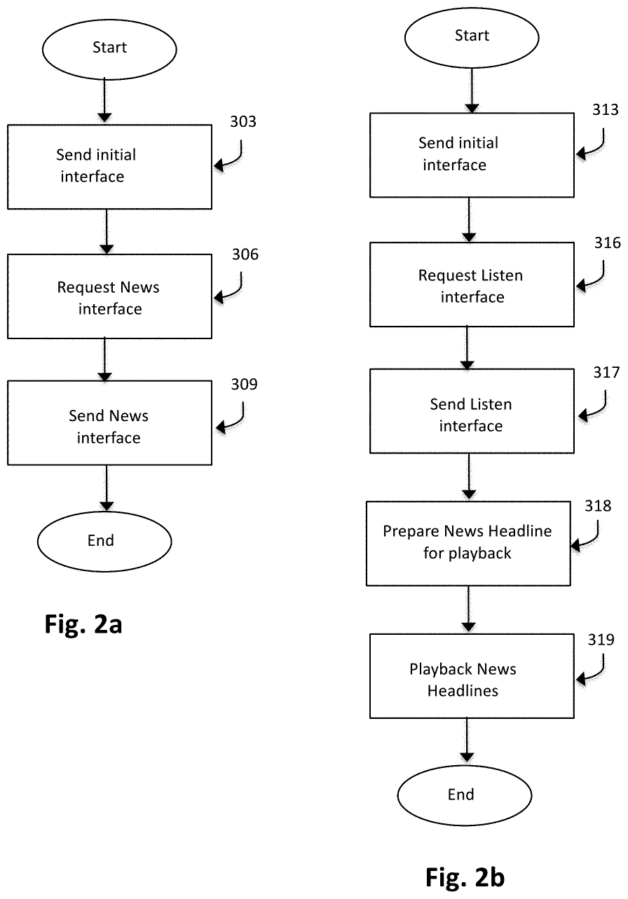

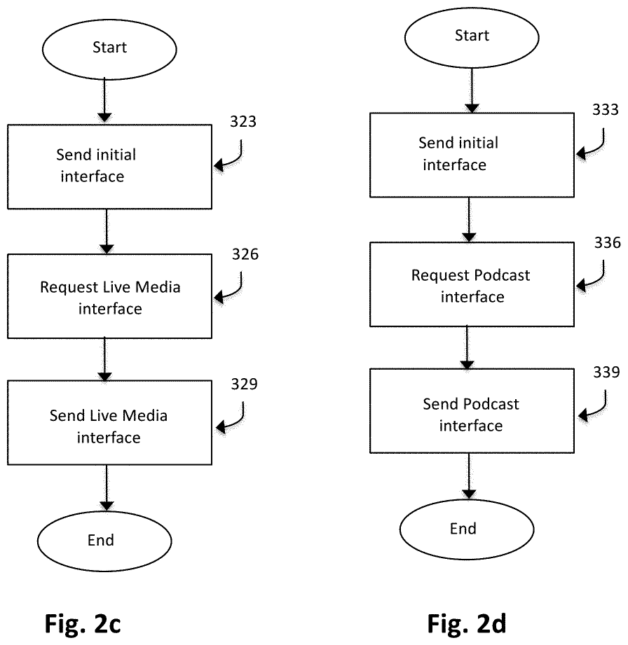

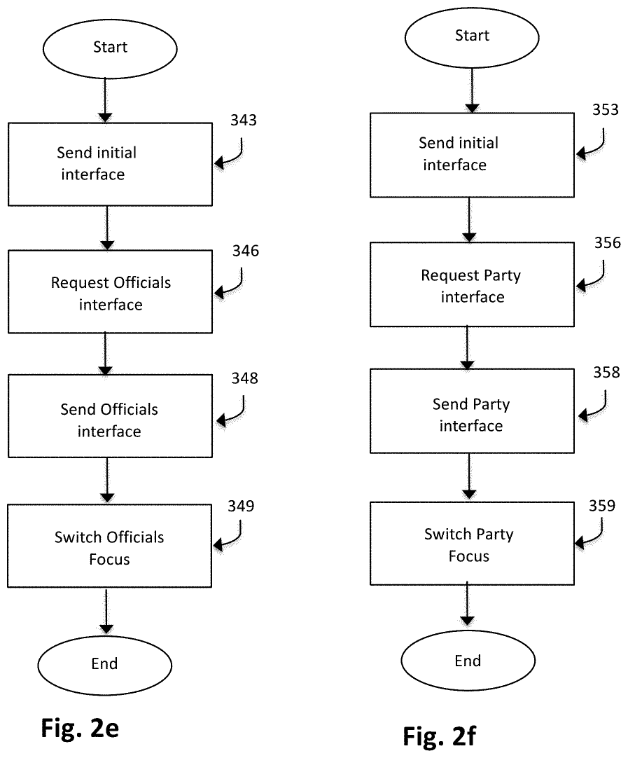

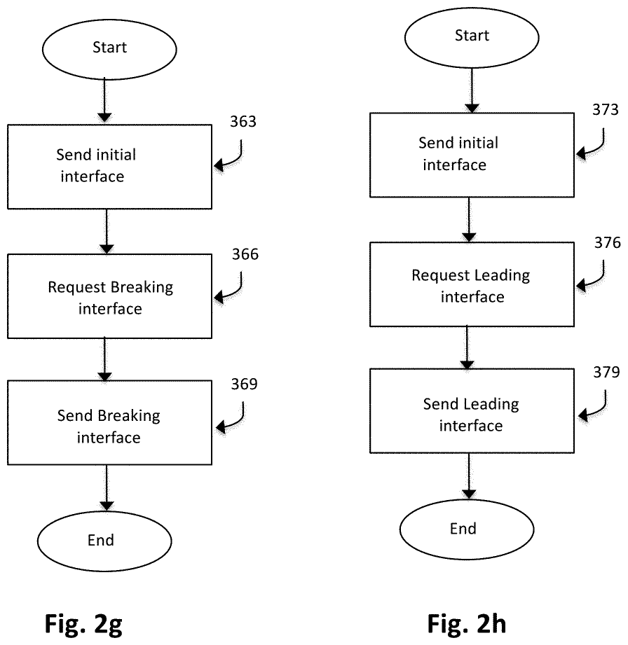

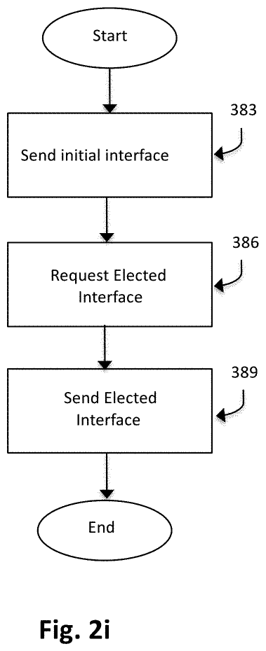

The news server 103 includes various software components that are stored on the memory 116 and are executable by the processor 113. These components include an operating system 163 and server logic 169. The server logic 169 may include a network server, may include one or more scanning/monitoring scripts 170, and may include one or more pages 173 (e.g., HyperText Markup Language (HTML) web pages). In addition, the server logic 169 may include image files 179 including, for example, information associated with live media steaming channels, elected officials, and local political party committees. The information associated may include, for example, static images, interactive images (i.e., a video sequence of images), and/or other relevant data to the live media steaming channels, elected officials, and local political party committees. In one aspect of this disclosure, the image files 179 take the form of PNG files. However, it is understood that other forms of image files 179 are of course possible. Within the pages 173 are user interfaces including news interface 180, listen interface 181, live media interface 182, podcast interface 183, officials interface 184, party interface 185, breaking interface 186, leading interface 187, and elected interface 188 that may be used in a multi-media aggregator and information hub process executed using the multi-media aggregator and information hub system 100, for example, as discussed further below in connection with FIG. 2a-2i.

In one aspect of this disclosure, the scripts 170 are JavaScript program files. However, it is understood that other program language files are of course possible. Within the scripts 170 are program files including program files to scan/monitor the political network sites pointer to by the URLs on the URL list 171 maintained by the news server 103. The sites are scan/monitor by executing scripts 170 for new news stories, new podcasts, or changes to live media steaming channels very 30 minutes. Of course, other scripts execution frequencies or schedules are possible. Results from scanning/monitoring may include any new news stories meta-data being stored in news stories 178, any new podcasts meta-data being stored in podcasts 176, and any changes to live media steaming channels meta-data being stored in live media 177.

The client 109 also includes software components that are stored on the memory 136 and are executable by the processor 133. These components include an operating system 203 and a network browser 206. By manipulating the browser 206, the pages 173 may be downloaded from the news server 103, having been transmitted by the server logic 169, which is stored on the memory 116 of the news server 103. Thus, the browser 206 and the server logic 169 may operate, for example, according to the dictates of the Hypertext Transfer Protocol (HTTP) employed on the World Wide Web or other suitable protocol. In this sense, the pages 173 may be created using a markup language, such as hypertext markup language (HTML), as is generally known by those with ordinary skill in the art. Alternatively, other programming languages or formats may be employed to create the pages 173, including extensible markup language (XML) or another mark-up language, JAVA, Active Server Page Scripting (ASP), JAVASCRIPT, C++, or other suitable computer languages and/or formats. It will also be appreciated that that the pages 173 may include other types of pages and/or data files. The memory 136 also may include image files 212.

The operating systems 163 and 203 are executed to control the allocation and usage of hardware resources, such as the memory, processing time and peripheral devices, in the news server 103 and the client 109, respectively. In this manner, the operating systems 163 and 203 serve as the foundation on which applications depend as is generally known by those with ordinary skill in the art.

Referring to FIGS. 2a-2i, several flowcharts are shown to illustrate example functionality/operations of a multi-media aggregator and information hub system (e.g., 100, shown in FIG. 1) in accordance with embodiments of this disclosure. More particularly, the flowcharts illustrate example functionality/operations of the multi-media aggregator and information hub system for several examples types of clients (e.g., news, podcasts, live media steaming channels, elected officials, and local political party committees clients) of the multi-media aggregator and information hub system. Processing blocks and decision blocks may be provided in the flowcharts. The processing blocks represent computer software and/or algorithm instructions or groups of instructions. Additionally, the decision blocks represent computer software and/or algorithm instructions, or groups of instructions, which affect the execution of the computer software and/or algorithm instructions represented by the processing blocks. The processing blocks and decision blocks (and other blocks shown) can represent steps performed by functionally equivalent circuits such as a digital signal processor circuit or an application specific integrated circuit (ASIC).

The flowcharts do not depict the syntax of any particular programming language. Rather, the flowcharts illustrate the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied. Thus, unless otherwise stated, the blocks described below are unordered; meaning that, when possible, the blocks can be performed in any convenient or desirable order including that sequential blocks can be performed simultaneously and vice versa. It will also be understood that various features from the flowcharts described below may be combined in some embodiments. Thus, unless otherwise stated, some features from the flowcharts described below may be combined with other features of the flowcharts described below, for example, to capture the various advantages and aspects of systems and methods associated with multi-media aggregator and information hub sought to be protected by this disclosure. It is also understood that various features from the flowcharts described below may be separated in some embodiments. For example, while the flowcharts are shown having many blocks, in some embodiments the illustrated method shown by these flowcharts may include fewer blocks or steps.

With reference now to FIG. 2a, a high-level flowchart is shown, illustrating example, functionality (e.g. logical functions) of the multi-media aggregator and information hub system 100. More particularly, in one example implementation, the flowchart of FIG. 2a may represent example method steps taken in operation of the multi-media aggregator and information hub system 100, for example, for a news client of the multi-media aggregator and information hub system 100. The method steps may include steps taken both in the news server 103, and in downloading (from the news server 103 to the client 109) and operation of a news interface 180 of the multi-media aggregator and information hub system 100. The news interface 180 may be displayed on a display 149 of the client 109 to allow a user of the client 109 to view and interact with the multi-media aggregator and information hub process.

As illustrated in FIG. 2a, the method begins at block 303, where a page 173 containing an initial interface 175 is sent from the news server 103 to the client 109 in response to a request from the client 109 to interact with the multi-media aggregator and information hub system. In accordance with some embodiments of this disclosure, the request is sent from the client 109 to the news server 103.

In one example implementation, the initial interface 175 is configured to allow the user of the client 109 to retrieve news stories 178 from the news server 103. The initial interface 175 allows the user of the client 109 to utilize input devices such as the keyboard 156 and the mouse 159 to start the retrieval of news stories.

It is understood that other types of input devices besides a keyboard and a mouse may additionally or alternatively be used to interact multi-media aggregator and information hub system 100. For example, in accordance with some embodiments of this disclosure, a microphone and/or an image capture device may additionally or alternatively be used.

In block 306, once the user of the client 109 has started the retrieval of news stories, a request is sent to the news server 103 for the news interface 180.

In block 309, when the news server 103 receives the news request from the client 109, the news server 103 will search for news stories 178 and matching metadata to populate the news interface 180 returned to client 109 to be displayed on a display 149 of the client.

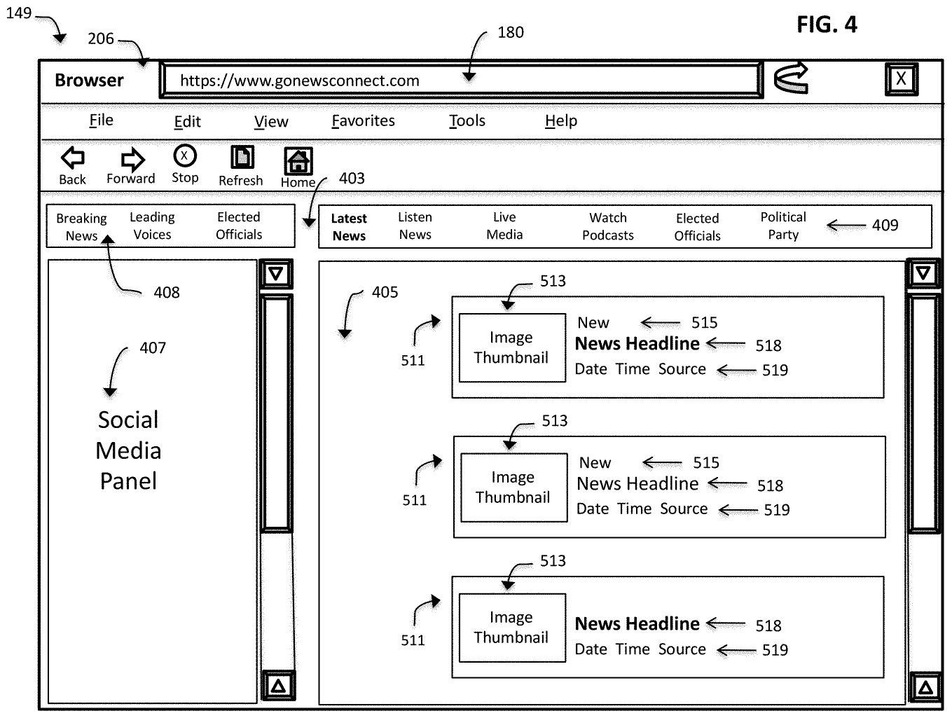

It will be appreciated that the news interface 180, one example of which is shown and discussed further in connection with FIG. 4, for example, may involve multiple pages 173 and/or may involve multiple hierarchical levels of menus, and may involve separate confirmation operations.

With reference now to FIG. 2b, a high-level flowchart is shown, illustrating example, functionality (e.g. logical functions) of the multi-media aggregator and information hub system 100. More particularly, in one example implementation, the flowchart of FIG. 2b may represent example method steps taken in operation of the multi-media aggregator and information hub system 100, for example, for a listen client of the multi-media aggregator and information hub system 100. The method steps may include steps taken both in the news server 103, and in downloading (from the news server 103 to the client 109) and operation of a listen interface 181 of the multi-media aggregator and information hub system 100. The listen interface 181 may be displayed on a display 149 of the client 109 to allow a user of the client 109 to view and interact with the multi-media aggregator and information hub process.

As illustrated in FIG. 2b, the method begins at block 313, where a page 173 containing an initial interface 175 is sent from the news server 103 to the client 109 in response to a request from the client 109 to interact with the multi-media aggregator and information hub system. In accordance with some embodiments of this disclosure, the request is sent from the client 109 to the news server 103.

In one example implementation, the initial interface 175 is configured to allow the user of the client 109 to listen to retrieve news stories 178 from the news server 103. The initial interface 175 allows the user of the client 109 to utilize input devices such as the keyboard 156 and the mouse 159 to start the retrieval of news stories.

It is understood that other types of input devices besides a keyboard and a mouse may additionally or alternatively be used to interact multi-media aggregator and information hub system 100. For example, in accordance with some embodiments of this disclosure, a microphone and/or an image capture device may additionally or alternatively be used.

In block 316, once the user of the client 109 has started the listening to retrieval of news stories, a request is sent to the news server 103 for the listen interface 180.

In block 317, when the news server 103 receives the listen request from the client 109, the news server 103 will search for news stories 178 and matching metadata to populate the listen interface 181 returned to client 109 to be displayed on a display 149 of the client.

In block 318, the news stories 178 used to populate the listen interface 181 and returned to client 109 are prepared for playback. First, the news story headlines will be processed for abbreviation expansion (for example: “Rep” to “Representative”). Second, the news story headlines will be processed to have specific words transpose (for example: “coronavirus” as “corona virus”, and “#” as “hash tag”) so the words can be pronounced by the synthesis voice better.

In addition, the news story headlines will be re-written before being presented to the voice synthesizer. The news story headline re-writing process randomly select a re-write rule from a set of re-write rules. The re-write rule has the following form:

<pre-text or nil><headline or source><connecting text><headline or source> Example re-write rule include:

Story by <source> reports that, <headline>

<source> reports, <headline>

Just in from, <source>, <headline>

Nil <headline>, a story by <source>

In block 319, the user of the client 109 can control how the news stories being displayed on a display 149 of the client 109 are playback. The user of the client 109 can control the starting and pausing of the playback and selecting the synthesis voice, voice pitch, and voice speed to use during playback.

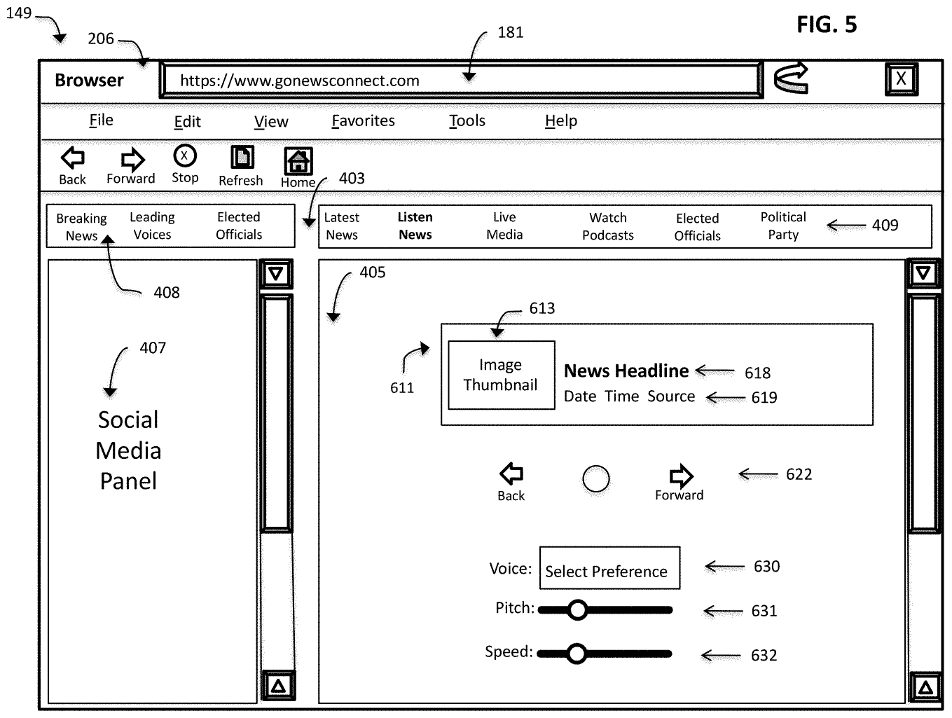

It will be appreciated that the listen interface 181, one example of which is shown and discussed further in connection with FIG. 5, for example, may involve multiple pages 173 and/or may involve multiple hierarchical levels of menus, and may involve separate confirmation operations.

With reference now to FIG. 2c, a high-level flowchart is shown, illustrating example, functionality (e.g. logical functions) of the multi-media aggregator and information hub system 100. More particularly, in one example implementation, the flowchart of FIG. 2c may represent example method steps taken in operation of the multi-media aggregator and information hub system 100, for example, for a live media client of the multi-media aggregator and information hub system 100. The method steps may include steps taken both in the news server 103, and in downloading (from the news server 103 to the client 109) and operation of a live media interface 182 of the multi-media aggregator and information hub system 100. The live media interface 182 may be displayed on a display 149 of the client 109 to allow a user of the client 109 to view and interact with the multi-media aggregator and information hub process.

As illustrated in FIG. 2c, the method begins at block 323, where a page 173 containing an initial interface 175 is sent from the news server 103 to the client 109 in response to a request from the client 109 to interact with the multi-media aggregator and information hub system. In accordance with some embodiments of this disclosure, the request is sent from the client 109 to the news server 103.

In one example implementation, the initial interface 175 is configured to allow the user of the client 109 to retrieve live media data 177 from the news server 103. The initial interface 175 allows the user of the client 109 to utilize input devices such as the keyboard 156 and the mouse 159 to start the retrieval of live media data.

It is understood that other types of input devices besides a keyboard and a mouse may additionally or alternatively be used to interact multi-media aggregator and information hub system 100. For example, in accordance with some embodiments of this disclosure, a microphone and/or an image capture device may additionally or alternatively be used.

In block 326, once the user of the client 109 has started the retrieval of live media data, a request is sent to the news server 103 for the live media interface 182.

In block 329, when the news server 103 receives the live media request from the client 109, the news server 103 will search for live media data 177 to populate the live media interface 182 returned to client 109 to be displayed on a display 149 of the client.

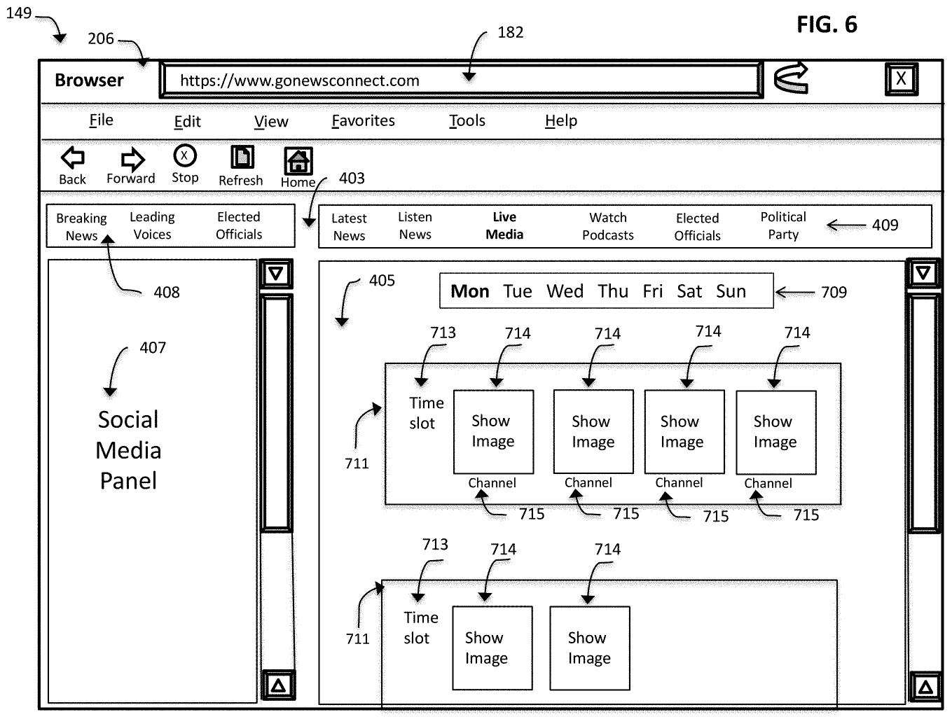

It will be appreciated that the live media interface 182, one example of which is shown and discussed further in connection with FIG. 6, for example, may involve multiple pages 173 and/or may involve multiple hierarchical levels of menus, and may involve separate confirmation operations.

With reference now to FIG. 2d, a high-level flowchart is shown, illustrating example, functionality (e.g. logical functions) of the multi-media aggregator and information hub system 100. More particularly, in one example implementation, the flowchart of FIG. 2d may represent example method steps taken in operation of the multi-media aggregator and information hub system 100, for example, for a podcast client of the multi-media aggregator and information hub system 100. The method steps may include steps taken both in the news server 103, and in downloading (from the news server 103 to the client 109) and operation of a podcast interface 183 of the multi-media aggregator and information hub system 100. The podcast interface 183 may be displayed on a display 149 of the client 109 to allow a user of the client 109 to view and interact with the multi-media aggregator and information hub process.

As illustrated in FIG. 2d, the method begins at block 333, where a page 173 containing an initial interface 175 is sent from the news server 103 to the client 109 in response to a request from the client 109 to interact with the multi-media aggregator and information hub system. In accordance with some embodiments of this disclosure, the request is sent from the client 109 to the news server 103.

In one example implementation, the initial interface 175 is configured to allow the user of the client 109 to retrieve podcasts 176 from the news server 103. The initial interface 175 allows the user of the client 109 to utilize input devices such as the keyboard 156 and the mouse 159 to start the retrieval of podcasts.

It is understood that other types of input devices besides a keyboard and a mouse may additionally or alternatively be used to interact multi-media aggregator and information hub system 100. For example, in accordance with some embodiments of this disclosure, a microphone and/or an image capture device may additionally or alternatively be used.

In block 336, once the user of the client 109 has started the retrieval of podcasts, a request is sent to the news server 103 for the podcast interface 183.

In block 339, when the news server 103 receives the podcast request from the client 109, the news server 103 will search for podcasts 176 and matching metadata to populate the podcast interface 183 returned to client 109 to be displayed on a display 149 of the client.

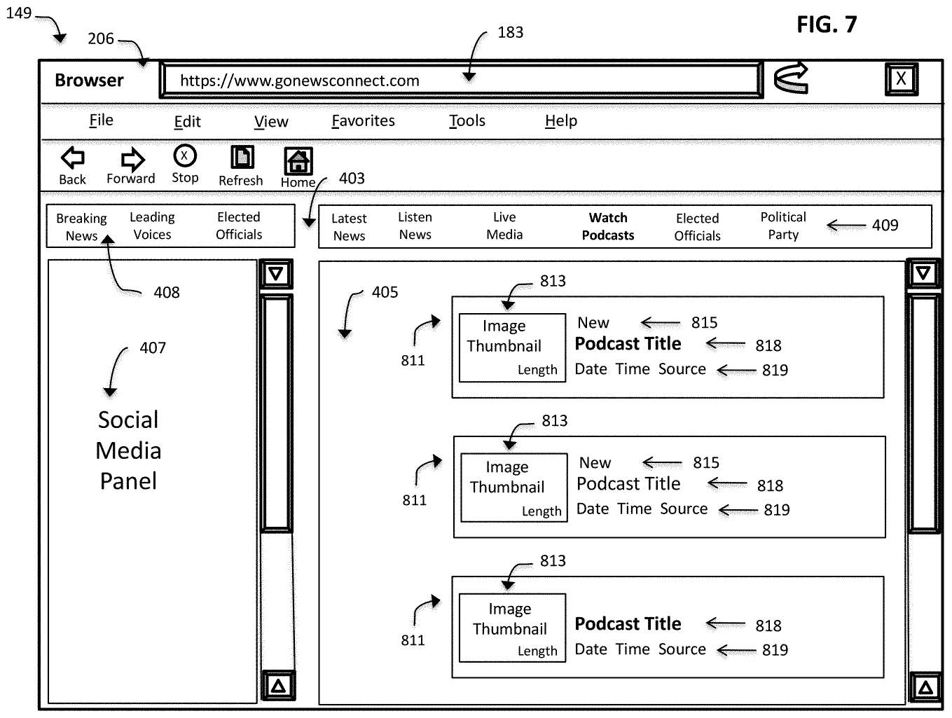

It will be appreciated that the podcast interface 183, one example of which is shown and discussed further in connection with FIG. 7, for example, may involve multiple pages 173 and/or may involve multiple hierarchical levels of menus, and may involve separate confirmation operations.

With reference now to FIG. 2e, a high-level flowchart is shown, illustrating example, functionality (e.g. logical functions) of the multi-media aggregator and information hub system 100. More particularly, in one example implementation, the flowchart of FIG. 2e may represent example method steps taken in operation of the multi-media aggregator and information hub system 100, for example, for a officials client of the multi-media aggregator and information hub system 100. The method steps may include steps taken both in the news server 103, and in downloading (from the news server 103 to the client 109) and operation of a officials interface 184 of the multi-media aggregator and information hub system 100. The officials interface 184 may be displayed on a display 149 of the client 109 to allow a user of the client 109 to view and interact with the multi-media aggregator and information hub process.

As illustrated in FIG. 2e, the method begins at block 343, where a page 173 containing an initial interface 175 is sent from the news server 103 to the client 109 in response to a request from the client 109 to interact with the multi-media aggregator and information hub system. In accordance with some embodiments of this disclosure, the request is sent from the client 109 to the news server 103.

In one example implementation, the initial interface 175 is configured to allow the user of the client 109 to retrieve elected officials 172 from the news server 103. The initial interface 175 allows the user of the client 109 to utilize input devices such as the keyboard 156 and the mouse 159 to start the retrieval of elected officials.

It is understood that other types of input devices besides a keyboard and a mouse may additionally or alternatively be used to interact multi-media aggregator and information hub system 100. For example, in accordance with some embodiments of this disclosure, a microphone and/or an image capture device may additionally or alternatively be used.

In block 346, once the user of the client 109 has started the retrieval of elected officials, a request is sent to the news server 103 for the officials interface 184.

In block 348, when the news server 103 receives the elected officials request from the client 109, the news server 103 will search for elected officials 172 and matching metadata to populate the officials interface 184 returned to client 109 to be displayed on a display 149 of the client.

In block 349, the user of the client 109 can switch the state and political branch (congress, senate, state leadership) focus of the elected officials being displayed on a display 149 of the client 109.

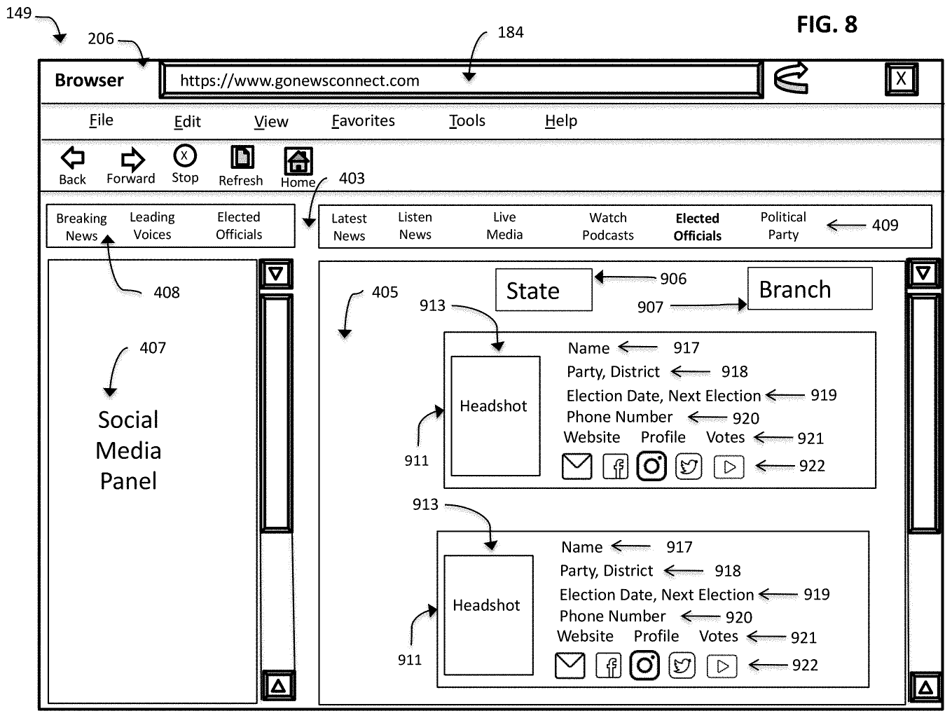

It will be appreciated that the officials interface 184, one example of which is shown and discussed further in connection with FIG. 8, for example, may involve multiple pages 173 and/or may involve multiple hierarchical levels of menus, and may involve separate confirmation operations.

With reference now to FIG. 2f, a high-level flowchart is shown, illustrating example, functionality (e.g. logical functions) of the multi-media aggregator and information hub system 100. More particularly, in one example implementation, the flowchart of FIG. 2f may represent example method steps taken in operation of the multi-media aggregator and information hub system 100, for example, for a officials client of the multi-media aggregator and information hub system 100. The method steps may include steps taken both in the news server 103, and in downloading (from the news server 103 to the client 109) and operation of a officials interface 184 of the multi-media aggregator and information hub system 100. The officials interface 184 may be displayed on a display 149 of the client 109 to allow a user of the client 109 to view and interact with the multi-media aggregator and information hub process.

As illustrated in FIG. 2f, the method begins at block 353, where a page 173 containing an initial interface 175 is sent from the news server 103 to the client 109 in response to a request from the client 109 to interact with the multi-media aggregator and information hub system. In accordance with some embodiments of this disclosure, the request is sent from the client 109 to the news server 103.

In one example implementation, the initial interface 175 is configured to allow the user of the client 109 to retrieve party committee 174 from the news server 103. The initial interface 175 allows the user of the client 109 to utilize input devices such as the keyboard 156 and the mouse 159 to start the retrieval of elected officials.

It is understood that other types of input devices besides a keyboard and a mouse may additionally or alternatively be used to interact multi-media aggregator and information hub system 100. For example, in accordance with some embodiments of this disclosure, a microphone and/or an image capture device may additionally or alternatively be used.

In block 356, once the user of the client 109 has started the retrieval of party committee, a request is sent to the news server 103 for the party interface 185.

In block 358, when the news server 103 receives the party committee request from the client 109, the news server 103 will search for party committee 174 and matching metadata to populate the party interface 185 returned to client 109 to be displayed on a display 149 of the client.

In block 359, the user of the client 109 can switch the level (national, state, country, town, district, precinct) focus of the party committee being displayed on a display 149 of the client 109.

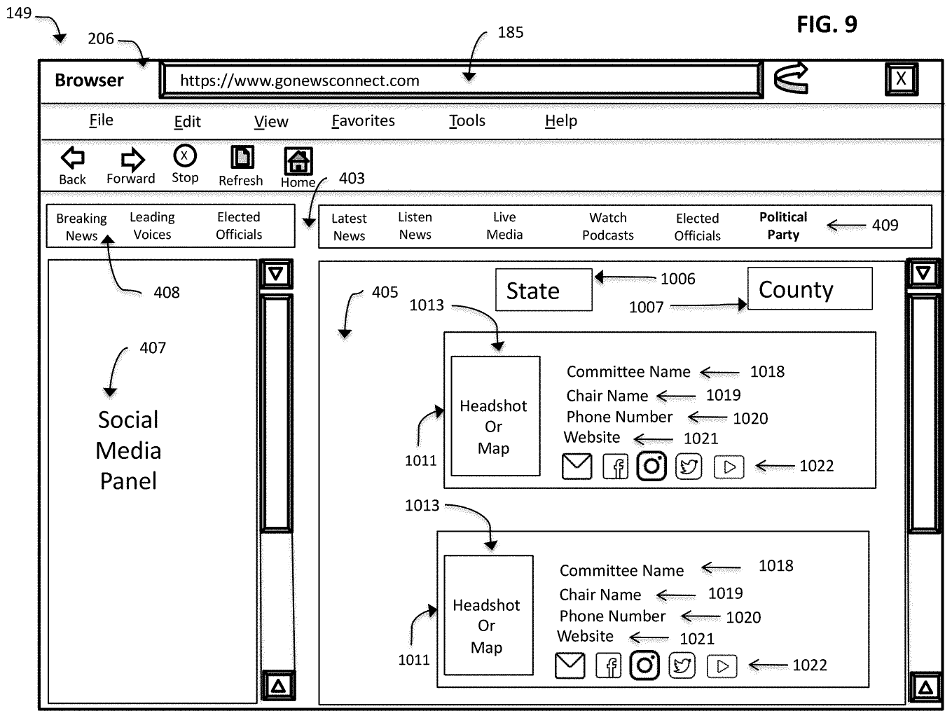

It will be appreciated that the party interface 185, one example of which is shown and discussed further in connection with FIG. 9, for example, may involve multiple pages 173 and/or may involve multiple hierarchical levels of menus, and may involve separate confirmation operations.

With reference now to FIG. 2g, a high-level flowchart is shown, illustrating example, functionality (e.g. logical functions) of the multi-media aggregator and information hub system 100. More particularly, in one example implementation, the flowchart of FIG. 2g may represent example method steps taken in operation of the multi-media aggregator and information hub system 100, for example, for a breaking client of the multi-media aggregator and information hub system 100. The method steps may include steps taken both in the news server 103, and in downloading (from the news server 103 to the client 109) and operation of a breaking interface 186 of the multi-media aggregator and information hub system 100. The breaking interface 186 may be displayed on a display 149 of the client 109 to allow a user of the client 109 to view and interact with the multi-media aggregator and information hub process.

As illustrated in FIG. 2g, the method begins at block 363, where a page 173 containing an initial interface 175 is sent from the news server 103 to the client 109 in response to a request from the client 109 to interact with the multi-media aggregator and information hub system. In accordance with some embodiments of this disclosure, the request is sent from the client 109 to the news server 103.

In one example implementation, the initial interface 175 is configured to allow the user of the client 109 to retrieve breaking news social media messages (for example Tweets posted on Twitter) from the news server 103. The initial interface 175 allows the user of the client 109 to utilize input devices such as the keyboard 156 and the mouse 159 to start the retrieval of social media messages.

It is understood that other types of input devices besides a keyboard and a mouse may additionally or alternatively be used to interact multi-media aggregator and information hub system 100. For example, in accordance with some embodiments of this disclosure, a microphone and/or an image capture device may additionally or alternatively be used.

In block 366, once the user of the client 109 has started the retrieval of social media messages, a request is sent to the news server 103 for the breaking interface 186.

In block 369, when the news server 103 receives the social media messages request from the client 109, the news server 103 will populate the breaking interface 186 with a script that will retrieve the breaking news social media messages from the social media platform and return it to client 109 to be displayed on a display 149 of the client.

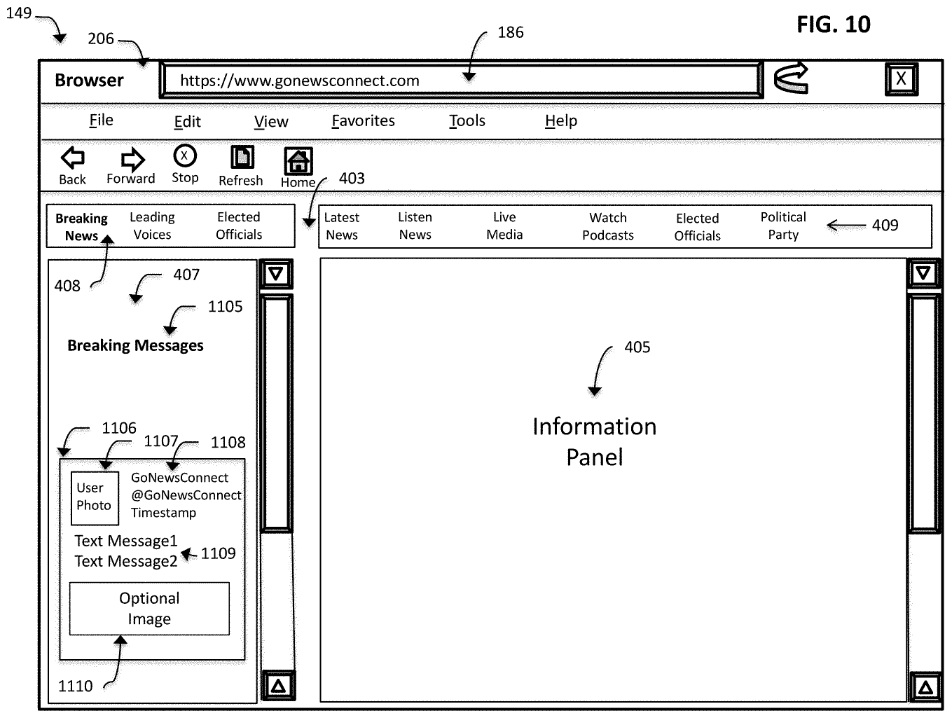

It will be appreciated that the breaking interface 186, one example of which is shown and discussed further in connection with FIG. 10, for example, may involve multiple pages 173 and/or may involve multiple hierarchical levels of menus, and may involve separate confirmation operations.

With reference now to FIG. 2h, a high-level flowchart is shown, illustrating example, functionality (e.g. logical functions) of the multi-media aggregator and information hub system 100. More particularly, in one example implementation, the flowchart of FIG. 2h may represent example method steps taken in operation of the multi-media aggregator and information hub system 100, for example, for a leading client of the multi-media aggregator and information hub system 100. The method steps may include steps taken both in the news server 103, and in downloading (from the news server 103 to the client 109) and operation of a leading interface 187 of the multi-media aggregator and information hub system 100. The leading interface 187 may be displayed on a display 149 of the client 109 to allow a user of the client 109 to view and interact with the multi-media aggregator and information hub process.

As illustrated in FIG. 2h, the method begins at block 373, where a page 173 containing an initial interface 175 is sent from the news server 103 to the client 109 in response to a request from the client 109 to interact with the multi-media aggregator and information hub system. In accordance with some embodiments of this disclosure, the request is sent from the client 109 to the news server 103.

In one example implementation, the initial interface 175 is configured to allow the user of the client 109 to retrieve leading voices social media messages (for example Tweets posted on Twitter) from the news server 103. The initial interface 175 allows the user of the client 109 to utilize input devices such as the keyboard 156 and the mouse 159 to start the retrieval of social media messages.

It is understood that other types of input devices besides a keyboard and a mouse may additionally or alternatively be used to interact multi-media aggregator and information hub system 100. For example, in accordance with some embodiments of this disclosure, a microphone and/or an image capture device may additionally or alternatively be used.

In block 376, once the user of the client 109 has started the retrieval of social media messages, a request is sent to the news server 103 for the leading interface 187.

In block 379, when the news server 103 receives the social media messages request from the client 109, the news server 103 will populate the leading interface 187 with a script that will retrieve the leading voices social media messages from the social media platform and return it to client 109 to be displayed on a display 149 of the client.

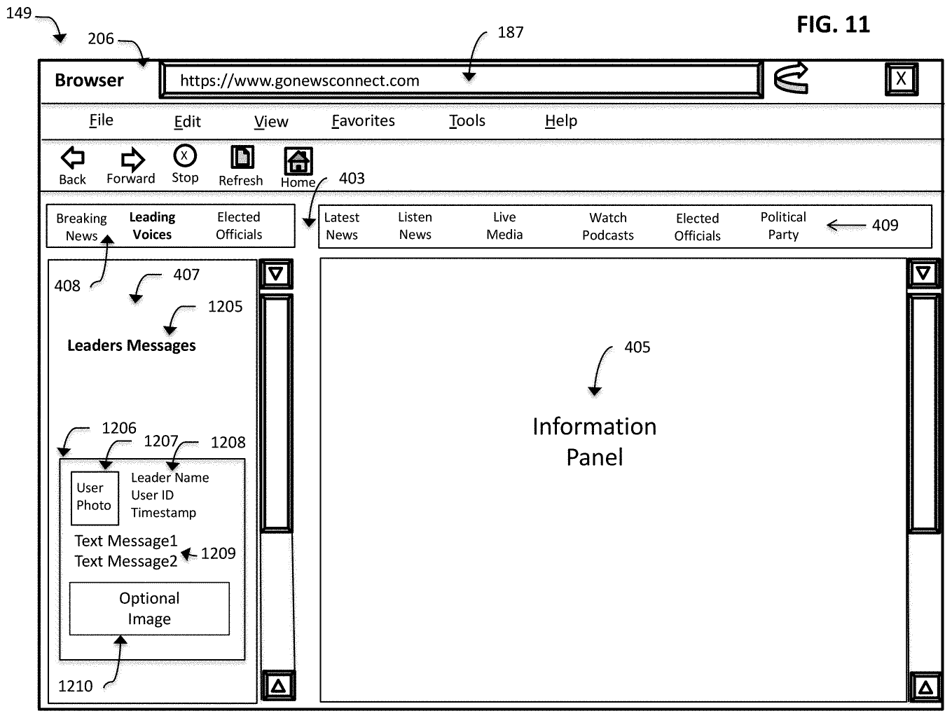

It will be appreciated that the leading interface 187, one example of which is shown and discussed further in connection with FIG. 11, for example, may involve multiple pages 173 and/or may involve multiple hierarchical levels of menus, and may involve separate confirmation operations.

With reference now to FIG. 2i, a high-level flowchart is shown, illustrating example, functionality (e.g. logical functions) of the multi-media aggregator and information hub system 100. More particularly, in one example implementation, the flowchart of FIG. 2i may represent example method steps taken in operation of the multi-media aggregator and information hub system 100, for example, for an elected client of the multi-media aggregator and information hub system 100. The method steps may include steps taken both in the news server 103, and in downloading (from the news server 103 to the client 109) and operation of a elected interface 188 of the multi-media aggregator and information hub system 100. The elected interface 188 may be displayed on a display 149 of the client 109 to allow a user of the client 109 to view and interact with the multi-media aggregator and information hub process.

As illustrated in FIG. 2i, the method begins at block 383, where a page 173 containing an initial interface 175 is sent from the news server 103 to the client 109 in response to a request from the client 109 to interact with the multi-media aggregator and information hub system. In accordance with some embodiments of this disclosure, the request is sent from the client 109 to the news server 103.

In one example implementation, the initial interface 175 is configured to allow the user of the client 109 to retrieve elected officials social media messages (for example Tweets posted on Twitter) from the news server 103. The initial interface 175 allows the user of the client 109 to utilize input devices such as the keyboard 156 and the mouse 159 to start the retrieval of social media messages.

It is understood that other types of input devices besides a keyboard and a mouse may additionally or alternatively be used to interact multi-media aggregator and information hub system 100. For example, in accordance with some embodiments of this disclosure, a microphone and/or an image capture device may additionally or alternatively be used.

In block 386, once the user of the client 109 has started the retrieval of social media messages, a request is sent to the news server 103 for the elected interface 188.

In block 389, when the news server 103 receives the social media messages request from the client 109, the news server 103 will populate the elected interface 188 with a script that will retrieve the elected officials social media messages from the social media platform and return it to client 109 to be displayed on a display 149 of the client.

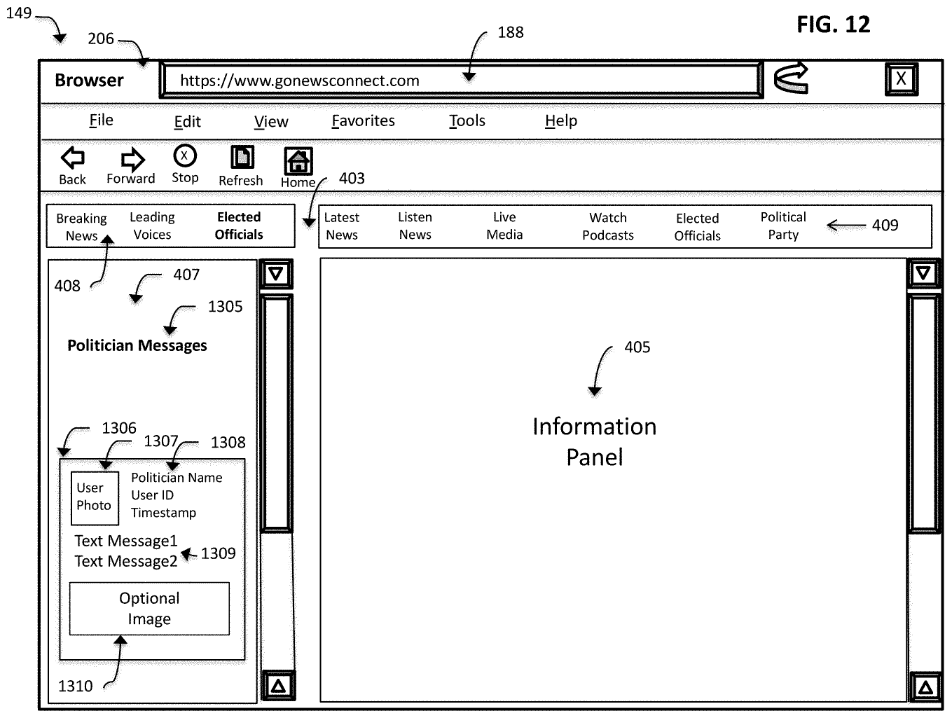

It will be appreciated that the elected interface 188, one example of which is shown and discussed further in connection with FIG. 12, for example, may involve multiple pages 173 and/or may involve multiple hierarchical levels of menus, and may involve separate confirmation operations.

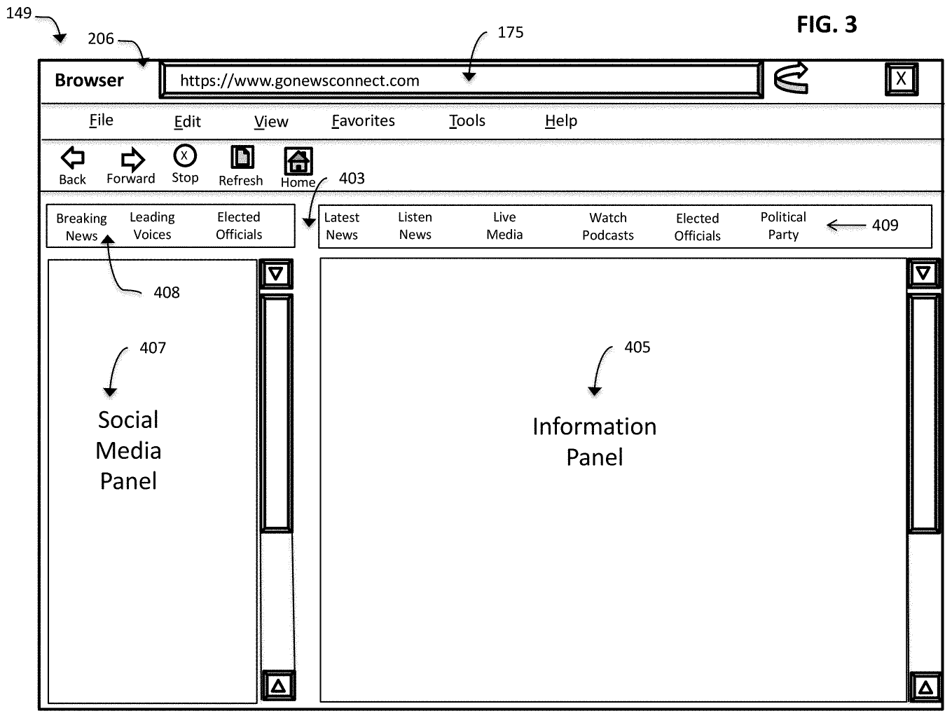

Referring now to FIGS. 3-12, shown are example interfaces in accordance with embodiments of this disclosure. As will be appreciated from discussions below, the illustrated interfaces are but a few of many potential interfaces that may be used in connection with multi-media aggregator and information hub system (e.g., 100, shown in FIG. 1) and methods in accordance with embodiments of this disclosure. As will also be appreciated from discussions below, the various features and elements of the interfaces, including the layouts and configurations of the interfaces, are illustrative only and may be changed, for example, depending on the application.

As illustrated in FIG. 3, the initial interface 175 includes a GUI 403 having a main navigation bar 409, social media navigation bar 408, information panel 405, and social media panel 407.

The main navigation bar 409 may be configured to allow the user of the client to actuate the secondary interfaces (news 180, listen 181, live media 182, podcast 183, officials 184, party 185) by clicking on appropriate anchor text (Latest News, Listen News, Watch Podcasts, Elected Officials, Political Party).

The social media navigation bar 408 may be configured to allow the user of the client to actuate the secondary interfaces (breaking 186, leading 187, elected 188) by clicking on appropriate anchor text (Breaking News, Leading Voices, Elected Officials).

It will be appreciated that the embodiment of the initial interface 175 shown in FIG. 3 and described above is only an example of the range of possible GUI interfaces that may suitably be employed. Additionally, it will be appreciated that while the initial interface 175 is described as having various anchor texts to perform a variety of functions, other means of performing the functions are of course possible. For example, images, check boxes, text fields (e.g., to enter “done” or “finish”), and buttons may be used to perform these functions and other contemplated functions.

As illustrated in FIG. 4, the news interface 180 includes a GUI 403 having a navigation bar 409 and information panel 405.

The navigation bar 409 may be configured to allow the user of the client to actuate the news interface 180 by clicking on Latest News anchor text. When the Latest News anchor text is actuated, the Latest News anchor text will be highlighted to indicate the news interface 180 is being displayed.

The news stories 178 retrieved from the news server 103 may be display as elements 511 within the information panel 405 having a news story related image thumbnail 513, line 515 displaying an indicator indicting the news story is being seen by the user of the client for the first time, line 518 displaying the news story headline as anchor text, and line 519 displaying the news story published date, published time, and the source of the news story. It will be appreciated that other news story meta data and news story details may be included in element 511.

The news story related image thumbnail 513 may be actuated to cause the browser 206 to open a new browser window. This new browser window will be loaded with the news story from the news source.

Similar to the image thumbnail 513, the news story headline anchor text 518 may be actuated to cause the browser 206 to open a new browser window. This new browser window will be loaded with the news story from the news source. When the news story headline anchor text is actuated, the news story headline anchor text will be “grayed out” to indicate the news story was read by user of the client.

It will be appreciated that the embodiment of the news interface 180 shown in FIG. 4 and described above is only an example of the range of possible GUI interfaces that may suitably be employed. Additionally, it will be appreciated that while the news interface 180 is described as having various anchor texts to perform a variety of functions, other means of performing the functions are of course possible. For example, images, check boxes, text fields (e.g., to enter “done” or “finish”), and buttons may be used to perform these functions and other contemplated functions.

As illustrated in FIG. 5, the listen interface 181 includes a GUI 403 having a navigation bar 409 and information panel 405.

The navigation bar 409 may be configured to allow the user of the client to actuate the listen interface 181 by clicking on Listen News anchor text. When the Listen News anchor text is actuated, the Listen News anchor text will be highlighted to indicate the listen interface 181 is being displayed.

The news stories 178 retrieved from the news server 103 may be display as element 611 within the information panel 405 having a news story related image thumbnail 613, line 618 displaying the news story headline as anchor text, and line 619 displaying the news story published date, published time, and the source of the news story. It will be appreciated that other news story meta data and news story details may be included in element 611.

The news story related image thumbnail 613 may be actuated to cause the browser 206 to open a new browser window. This new browser window will be loaded with the news story from the news source. The actuation will also cause the playback (audio output) to stop.

Similar to the image thumbnail 613, the news story headline anchor text 618 may be actuated to cause the browser 206 to open a new browser window. This new browser window will be loaded with the news story from the news source. The actuation will also cause the playback (audio output) to stop.

The information panel 405 may be configured with line 622 displaying the Back, Play/Pause, and Forward buttons for controlling the playback (audio output) of the news story. The Play/Pause button of line 622 may be actuated to start the playback and may be actuated again to stop the playback. The Back button of line 622 may be actuated to display the previous news story on the list of news stories 178 retrieved from the news server 103. The Forward button of line 622 may be actuated to display the next news story on the list of news stories 178 retrieved from the news server 103.

The information panel 405 may be configured with line 630 displaying a voice preference pull-down menu. The voice preference pull-down menu may be actuated to allow the user of the client to select a synthesis voice to be used during playback (audio output).

The information panel 405 may be configured with line 631 displaying a voice pitch slider. The voice pitch slider may be actuated to allow the user of the client to select the synthesis voice's pitch to be used during playback (audio output).

The information panel 405 may be configured with line 632 displaying a voice speed slider. The voice speed slider may be actuated to allow the user of the client to select the synthesis voice's speed to be used during playback (audio output).

It will be appreciated that the embodiment of the listen interface 181 shown in FIG. 5 and described above is only an example of the range of possible GUI interfaces that may suitably be employed. Additionally, it will be appreciated that while the listen interface 181 is described as having various anchor texts and sliders to perform a variety of functions, other means of performing the functions are of course possible. For example, images, check boxes, text fields (e.g., to enter “done” or “finish”), and buttons may be used to perform these functions and other contemplated functions.

As illustrated in FIG. 6, live media interface 182 includes a GUI 403 having a navigation bar 409 and information panel 405.

The navigation bar 409 may be configured to allow the user of the client to actuate the live media interface 182 by clicking on Live Media anchor text. When the Live Media anchor text is actuated, the Live Media anchor text will be highlighted to indicate the live media interface 182 is being displayed.

The information panel 405 may be configured with a secondary navigation bar 709 displaying the days of the week to allow the user of the client to actuate the live media program guide for a specific day of the week by clicking on a day of the week anchor text. When a day of the week anchor text is actuated, that day of the week anchor text will be highlighted to indicate that day of the week program guide is being displayed.

The live media 177 guide is retrieved from the news server 103 may be display as elements 711 within the information panel 405 having a time slot value 713, show/broadcast images 714, and show/broadcast steaming media channel name 715 below each show/broadcast image 714.

The show/broadcast image 714 may be actuated to cause the browser 206 to open a new browser window. This new browser window will be loaded with the live steam from the show/broadcast source.

It will be appreciated that the embodiment of the live media interface 182 shown in FIG. 6 and described above is only an example of the range of possible GUI interfaces that may suitably be employed. Additionally, it will be appreciated that while the live media interface 182 is described as having various anchor texts to perform a variety of functions, other means of performing the functions are of course possible. For example, images, check boxes, text fields (e.g., to enter “done” or “finish”), and buttons may be used to perform these functions and other contemplated functions.

As illustrated in FIG. 7, the podcast interface 183 includes a GUI 403 having a navigation bar 409 and information panel 405.

The navigation bar 409 may be configured to allow the user of the client to actuate the podcast interface 183 by clicking on Watch Podcast anchor text. When the Watch Podcast anchor text is actuated, the Watch Podcast anchor text will be highlighted to indicate the podcast interface 183 is being displayed.

The podcasts 176 retrieved from the news server 103 may be display as elements 811 within the information panel 405 having a podcast related image thumbnail 813 with the podcast length superimposed on it, line 815 displaying an indicator indicting the podcast is being seen by the user of the client for the first time, line 818 displaying the podcast title as anchor text, and line 819 displaying the podcast published date, published time, and the source of the podcast. It will be appreciated that other podcast meta data and podcast details may be included in element 511.

The podcast related image thumbnail 813 may be actuated to cause the browser 206 to open a new browser window. This new browser window will be loaded with the podcast from the podcast source.

Similar to the image thumbnail 811, the podcast title anchor text 818 may be actuated to cause the browser 206 to open a new browser window. This new browser window will be loaded with the podcast from the podcast source. When the podcast title anchor text is actuated, the podcast title anchor text will be “grayed out” to indicate the podcast was watched by user of the client.

It will be appreciated that the embodiment of the podcast interface 183 shown in FIG. 7 and described above is only an example of the range of possible GUI interfaces that may suitably be employed. Additionally, it will be appreciated that while the podcast interface 183 is described as having various anchor texts to perform a variety of functions, other means of performing the functions are of course possible. For example, images, check boxes, text fields (e.g., to enter “done” or “finish”), and buttons may be used to perform these functions and other contemplated functions.

As illustrated in FIG. 8, officials interface 184 includes a GUI 403 having a navigation bar 409 and information panel 405.

The navigation bar 409 may be configured to allow the user of the client to actuate the officials interface 184 by clicking on Elected Officials anchor text. When the Elected Officials anchor text is actuated, the Elected Officials anchor text will be highlighted to indicate the officials interface 184 is being displayed.

The information panel 405 may be configured with State pull-down menu 906 and Branch pull-down menu 907. The user of the client may actuate the State pull-down menu 906 to switch focus (by state) of the elected officials being displayed. The user of the client may actuate the Branch pull-down menu 907 to switch focus (congress, senate, state leadership) of the elected officials being displayed.

The elected officials 172 data retrieved from the news server 103 may be display as elements 911 within the information panel 405 having an elected official's headshot image thumbnail 913, line 917 displaying the elected official's name, line 918 displaying the political party and political district of the elected official, line 919 displaying the date the elected official was first elected and the date of the elected official's next election, line 920 displaying the elected official's phone number anchor text, line 921 displaying the elected official's website link, web link to a background profile of the elected official, and a web link to the voting record of the elected official, and line 922 displaying social media icons linking to elected official's social media accounts (for example eMail, Facebook, Instagram, Twitter, and YouTube). It will be appreciated that other elected official meta data and elected official details may be included in element 911.

The elected official's phone number anchor text 920 may be actuated to cause the browser 206 to dial the elected official's phone number if the client 109 such as a smart phone or a tablet supports direct dialing, or to start up an appropriate client 109 application program such as Skype, Line, or Zoom to initiate a VoIP (Voice over IP) call.

The elected official's website link on line 921 may be actuated to cause the browser 206 to open a new browser window. This new browser window will be loaded with the elected official's website.

The elected official's profile link on line 921 may be actuated to cause the browser 206 to open a new browser window. This new browser window will be loaded with the elected official's background profile from the Biographical Directory of the United States Congress website or similar websites.

The elected official's votes link on line 921 may be actuated to cause the browser 206 to open a new browser window. This new browser window will be loaded with the elected official's voting record as reported by the Center For Legislative Accountability website or similar websites.

The social media icons, eMail, Facebook, Instagram, Twitter, and YouTube, on line 922 may be actuated to cause the browser 206 to open a new browser window. This new browser window will be loaded with the elected official's social media account web page.

It will be appreciated that the embodiment of the officials interface 184 shown in FIG. 8 and described above is only an example of the range of possible GUI interfaces that may suitably be employed. Additionally, it will be appreciated that while the officials interface 184 is described as having various anchor texts to perform a variety of functions, other means of performing the functions are of course possible. For example, images, check boxes, text fields (e.g., to enter “done” or “finish”), and buttons may be used to perform these functions and other contemplated functions.

As illustrated in FIG. 9, party interface 185 includes a GUI 403 having a navigation bar 409 and information panel 405.

The navigation bar 409 may be configured to allow the user of the client to actuate the party interface 185 by clicking on Political Party anchor text. When the Political Party anchor text is actuated, the Political Party anchor text will be highlighted to indicate the party interface 185 is being displayed.

The information panel 405 may be configured with State pull-down menu 1006 and County pull-down menu 1007. The user of the client may actuate the State pull-down menu 1006 to switch focus (by state) of the party committee data being displayed. The user of the client may actuate the County pull-down menu 1007 to switch focus (by state county) of the party committee data being displayed.

The party committee 174 data retrieved from the news server 103 may be display as elements 1011 within the information panel 405 having an party committee chairman headshot image thumbnail or state/county/town map 1013, line 1018 displaying the party committee's name, line 1019 displaying the party committee's chairman name, line 1020 displaying the party committee's phone number anchor text, line 1021 displaying the party committee's website link, and line 1022 displaying social media icons linking to party committee's social media accounts (for example eMail, Facebook, Instagram, Twitter, and YouTube). It will be appreciated that other party committee meta data and party committee details may be included in element 1011.

The party committee's phone number anchor text 1020 may be actuated to cause the browser 206 to dial the party committee's phone number if the client 109 such as a smart phone or a tablet supports direct dialing, or to start up an appropriate client 109 application program such as Skype, Line, or Zoom to initiate a VoIP (Voice over IP) call.

The party committee's website link on line 1021 may be actuated to cause the browser 206 to open a new browser window. This new browser window will be loaded with the party committee's website.

The social media icons, eMail, Facebook, Instagram, Twitter, and YouTube, on line 1022 may be actuated to cause the browser 206 to open a new browser window. This new browser window will be loaded with the party committee's social media account web page.

It will be appreciated that the embodiment of the party interface 185 shown in FIG. 9 and described above is only an example of the range of possible GUI interfaces that may suitably be employed. Additionally, it will be appreciated that while the party interface 185 is described as having various anchor texts to perform a variety of functions, other means of performing the functions are of course possible. For example, images, check boxes, text fields (e.g., to enter “done” or “finish”), and buttons may be used to perform these functions and other contemplated functions.

As illustrated in FIG. 10, breaking interface 186 includes a GUI 403 having a navigation bar 408 and social media panel 407.

The navigation bar 407 may be configured to allow the user of the client to actuate the breaking interface 186 by clicking on Breaking News anchor text. When the Breaking News anchor text is actuated, the Breaking News anchor text will be highlighted to indicate the breaking interface 186 is being displayed.

The multi-media aggregator and information hub system will maintain social media accounts. Messages posted to those accounts are considered to be Breaking News.

The social media panel 407 may be configured with line 1105 displaying the title of social media messages being display.

Breaking social media messages retrieved from the social media server may be display as elements 1106 within the social media panel 407 having a social media user photo image 1107, line 1108 displaying social media user's account name, social media user's account ID, and message timestamp, line 1109 displaying the text of the social media message, and line 1110 displaying an optional image of the social media message. It will be appreciated that other social media message meta data and social media message details may be included in element 1106.

It will be appreciated that the embodiment of the breaking interface 186 shown in FIG. 10 and described above is only an example of the range of possible GUI interfaces that may suitably be employed. Additionally, it will be appreciated that while the breaking interface 186 is described as having various anchor texts to perform a variety of functions, other means of performing the functions are of course possible. For example, images, check boxes, text fields (e.g., to enter “done” or “finish”), and buttons may be used to perform these functions and other contemplated functions.

As illustrated in FIG. 11, leading interface 187 includes a GUI 403 having a navigation bar 408 and social media panel 407.

The navigation bar 408 may be configured to allow the user of the client to actuate the leading interface 187 by clicking on Leading Voices anchor text. When the Leading Voices anchor text is actuated, the Leading Voices anchor text will be highlighted to indicate the leading interface 187 is being displayed.

The multi-media aggregator and information hub system will maintain social media accounts tracking social media messages posted by influential political observers. The administrator of the multi-media aggregator and information hub system will determine who is consider an influential political observer. Messages posted to those accounts are considered to be Leading Voices.

The social media panel 407 may be configured with line 1205 displaying the title of social media messages being display.

Leading social media messages retrieved from the social media server may be display as elements 1206 within the social media panel 407 having a social media user photo image 1207, line 1208 displaying social media user's account name, social media user's account ID, and message timestamp, line 1209 displaying the text of the social media message, and line 1210 displaying an optional image of the social media message. It will be appreciated that other social media message meta data and social media message details may be included in element 1206.

It will be appreciated that the embodiment of the leading interface 187 shown in FIG. 11 and described above is only an example of the range of possible GUI interfaces that may suitably be employed. Additionally, it will be appreciated that while the leading interface 187 is described as having various anchor texts to perform a variety of functions, other means of performing the functions are of course possible. For example, images, check boxes, text fields (e.g., to enter “done” or “finish”), and buttons may be used to perform these functions and other contemplated functions.

As illustrated in FIG. 12, elected interface 188 includes a GUI 403 having a navigation bar 408 and social media panel 407.

The navigation bar 408 may be configured to allow the user of the client to actuate the elected interface 188 by clicking on Elected Officials anchor text. When the Elected Officials anchor text is actuated, the Elected Officials anchor text will be highlighted to indicate the elected interface 188 is being displayed.

The multi-media aggregator and information hub system will maintain social media accounts tracking social media messages posted by elected officials. Messages posted to those accounts are considered to be elected officials social media messages.

The social media panel 407 may be configured with line 1305 displaying the title of social media messages being display.

Elected officials social media messages retrieved from the social media server may be display as elements 1306 within the social media panel 407 having a social media user photo image 1307, line 1308 displaying social media user's account name, social media user's account ID, and message timestamp, line 1309 displaying the text of the social media message, and line 1310 displaying an optional image of the social media message. It will be appreciated that other social media message meta data and social media message details may be included in element 1306.

It will be appreciated that the embodiment of the elected interface 188 shown in FIG. 12 and described above is only an example of the range of possible GUI interfaces that may suitably be employed. Additionally, it will be appreciated that while the elected interface 188 is described as having various anchor texts to perform a variety of functions, other means of performing the functions are of course possible. For example, images, check boxes, text fields (e.g., to enter “done” or “finish”), and buttons may be used to perform these functions and other contemplated functions.

Where the server logic 169 include software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the server logic 169 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It will be appreciated that the systems and methods described above may be varied in a variety of suitable ways. For example, the systems and methods described above have been described in terms of managing political information and stories. However, it will be appreciated that the system and method may be utilized in managing other sorts of related information.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention may have been described above with respect to only one or more of several illustrated embodiments, such feature may be combined with one or more other features of the other embodiments, as may be desired and advantageous for any given or particular application.

Accordingly, it is submitted that that scope of the patent should not be limited to the described embodiments but rather should be limited only by the spirit and scope of the following claims.

What is claimed is:

1. A method for aggregating multi-media sources and streamlining delivery of political information, comprising:
receiving, at an input of a news server, a request from a client coupled to the news server, the request relating to at least one function or operation of a multi-media aggregator and information hub system;
taking or performing at least one action in response to the client request, the at least one action including one or more of:
sending a page containing a news client interface from the news server to the client in response to the request from the client corresponding to a request for latest political news;
sending a page containing a listen client interface from the news server to the client in response to the request from the client corresponding to a request for listen political news;
sending a page containing a live media client interface from the news server to the client in response to the request from the client corresponding to a request for live media program guide;
sending a page containing a podcast client interface from the news server to the client in response to the request from the client corresponding to a request to watch podcasts;
sending a page containing an officials client interface from the news server to the client in response to the request from the client corresponding to a request for elected officials;
sending a page containing a party client interface from the news server to the client in response to the request from the client corresponding to a request for political party;
sending a page containing a breaking news client interface from the news server to the client in response to the request from the client corresponding to a request for breaking news; and
sending a page containing a leading client interface may be sent from the news server to the client in response to the request from the client corresponding to a request for leading voices.

2. The method of claim 1, wherein the news server is communicatively coupled to at least one memory device, and the at least one memory device is searched for particular information or data based on or in response to the client request.

3. The method of claim 2, wherein the political information and new stories are regularly or semi-regularly collected from a plurality of sources and stored on the at least one memory device.

4. The method of claim 3, wherein the plurality of sources are regularly or semi-regularly evaluated for authenticity.

5. The method of claim 1, wherein the client request is received in response to the client's interaction with an initial interface presented on a device of the client, the initial interface being presented on the client device in response to an initial request from the client to interact with the multi-media aggregator and information hub system.

6. The method of claim 1, wherein the news stories used to populate the listen interface and returned to the client are prepared for playback, with headlines of the news stories being processed for abbreviation expansion and to have specific words transpose so the words can be pronounced better by voice synthesizer functionality implemented on the multi-media aggregator and information hub system.

7. The method of claim 6, wherein the news story headlines are re-written in accordance with a news story headline re-writing process before being presented to the voice synthesizer, the news story headline re-writing process randomly selecting a re-write rule from a set of re-write rules.

8. The method of claim 1, wherein preferences of the client are learned by the multi-media aggregator and information hub system and used to optimize the page(s) sent to the client.

9. The method of claim 8, wherein the client preferences are learned based on an analysis of at least one of: historical data and interactions of the client with the multi-media aggregator and information hub system.

10. The method of claim 8, wherein information presented on the page(s) is displayed and organized in accordance with the learned client preferences.

11. The method of claim 10, wherein the information includes at least one of static images, dynamic images and text.

12. A multi-media aggregator and information hub system, comprising:
at least one processor;
at least one memory device coupled to the at least one processor, the at least one processor and the at least one memory device configured to:
receive, at an input of a news server, a request from a client coupled to the news server, the request relating to at least one function or operation of the multi-media aggregator and information hub system; and
take or perform at least one action in response to the client request, the at least one action including one or more of:
sending a page containing a news client interface from the news server to the client in response to the request from the client corresponding to a request for latest political news;
sending a page containing a listen client interface from the news server to the client in response to the request from the client corresponding to a request for listen political news;
sending a page containing a live media client interface from the news server to the client in response to the request from the client corresponding to a request for live media program guide;
sending a page containing a podcast client interface from the news server to the client in response to the request from the client corresponding to a request to watch podcasts;
sending a page containing an officials client interface from the news server to the client in response to the request from the client corresponding to a request for elected officials;
sending a page containing a party client interface from the news server to the client in response to the request from the client corresponding to a request for political party;
sending a page containing a breaking news client interface from the news server to the client in response to the request from the client corresponding to a request for breaking news; and
sending a page containing a leading client interface may be sent from the news server to the client in response to the request from the client corresponding to a request for leading voices.

13. The system of claim 12, wherein the client request is received in response to the client's interaction with an initial interface presented on a device of the client, the initial interface being presented on the client device in response to an initial request from the client to interact with the multi-media aggregator and information hub system.

14. The system of claim 12, wherein the news stories used to populate the listen interface and returned to the client are prepared for playback, with headlines of the news stories being processed for abbreviation expansion and to have specific words transpose so the words can be pronounced better by voice synthesizer functionality implemented on the multi-media aggregator and information hub system.

15. The system of claim 12, wherein the news story headlines are re-written in accordance with a news story headline re-writing process before being presented to the voice synthesizer, the news story headline re-writing process randomly selecting a re-write rule from a set of re-write rules.

16. The system of claim 12, wherein preferences of the client are learned by the multi-media aggregator and information hub system and used to optimize the page(s) sent to the client.

17. The system of claim 16, wherein the client preferences are learned based on an analysis of at least one of: historical data and interactions of the client with the multi-media aggregator and information hub system.

18. The system of claim 16, wherein information presented on the page(s) is displayed and organized in accordance with the learned client preferences.

19. The system of claim 18, wherein the information includes at least one of static images, dynamic images and text.

20. A non-transient computer readable medium containing program instructions for causing a computer to perform the method of:
receiving, at an input of a news server, a request from a client coupled to the news server, the request relating to at least one function or operation of a multi-media aggregator and delivery of political information system;
taking or performing at least one action in response to the client request, the at least one action including one or more of:
sending a page containing a news client interface from the news server to the client in response to the request from the client corresponding to a request for latest political news;
sending a page containing a listen client interface from the news server to the client in response to the request from the client corresponding to a request for listen political news;
sending a page containing a live media client interface from the news server to the client in response to the request from the client corresponding to a request for live media program guide;
sending a page containing a podcast client interface from the news server to the client in response to the request from the client corresponding to a request to watch podcasts;
sending a page containing an officials client interface from the news server to the client in response to the request from the client corresponding to a request for elected officials;
sending a page containing a party client interface from the news server to the client in response to the request from the client corresponding to a request for political party;
sending a page containing a breaking client interface from the news server to the client in response to the request from the client corresponding to a request for breaking news; and
sending a page containing a leading client interface may be sent from the news server to the client in response to the request from the client corresponding to a request for leading voices.
